(19) United States
(12) Patent Application Publication
(10) Pub. No.: US 2025/0388172 A1
(43) Pub. Date: Dec. 25, 2025

(54) WINDOW MIRROR ASSEMBLY, LIDAR, AUTOMATIC DRIVING DEVICE AND ASSEMBLY PROCESS

(71) Applicant: SUTENG INNOVATION TECHNOLOGY CO., LTD., Shenzhen (CN)

(72) Inventors: Enkang CUI, Shenzhen (CN); Teng ZHANG, Shenzhen (CN); Huan WANG, Shenzhen (CN); Dongyu YANG, Shenzhen (CN); Guoguang LIU, Shenzhen (CN)

(73) Assignee: SUTENG INNOVATION TECHNOLOGY CO., LTD., Shenzhen (CN)

(21) Appl. No.: 19/236,961

(22) Filed: Jun. 12, 2025

(30) Foreign Application Priority Data
Jun. 20, 2024 (CN) 202410801730.5

(51) Int. Cl. B60R 1/12; B60K 35/40

(52) U.S. Cl. CPC B60R 1/12; B60K 35/405; B60K 2360/21; B60R 2001/1253; B60R 2300/301

(57) ABSTRACT

A window mirror assembly, a LiDAR, an automatic driving device, and an assembly process are provided. The window mirror assembly includes a lens barrel, two window mirrors, and a hygroscopic structure. The lens barrel has an optical channel. The two window mirrors are respectively located at two ends of the optical channel and are both sealed and connected to the lens barrel. The hygroscopic structure includes a hygroscopic member and a extinction member. The hygroscopic member is arranged in the optical channel and is connected to the channel wall of the optical channel. The extinction member is arranged on the side of the hygroscopic member facing the optical channel.

### CROSS-REFERENCE TO RELATED APPLICATION

The present application claims the benefit of priority to Chinese Patent Application No. 202410801730.5, filed on Jun. 20, 2024, which is hereby incorporated by reference in its entirety.

### TECHNICAL FIELD

The present application relates to the field of LiDAR technology, and particularly, relates to a window mirror assembly, LiDAR, automatic driving device and assembly process.

### BACKGROUND

LiDAR is a radar system that emits laser beams to detect position, speed, and other characteristic values of a target. First emit a detection laser to the target, and then compare the received echo signal reflected from the target with the emitted signal. After processing, the relevant information of the target can be obtained such as distance, direction, altitude, speed, attitude, and even shape.

In the related art, the outer housing and the window mirror of the LiDAR enclose an internal cavity, and the optoelectronic devices are placed in the internal cavity. On the one hand, the window mirror plays a role of separating the outside world, and on the other hand, it can allow the emitted and received laser beams to pass through without blocking the laser beams and affecting detection.

### SUMMARY

The embodiments of the present application provide a window mirror assembly, a LiDAR, an autonomous driving device, and an assembly process, which are intended to utilize a hygroscopic member to absorb moisture in an optical channel to reduce the probability of moisture turning into condensation and adhering to the inner wall of the window mirror, thereby ensuring that the LiDAR can have a higher detection accuracy.

An embodiment of the present application provides a window mirror assembly, which is applied to a LiDAR. The window mirror assembly includes a lens barrel, two window mirrors, and a hygroscopic structure. The lens barrel has an optical channel. The two window mirrors are respectively located at two ends of the optical channel and are both sealed and connected to the lens barrel. The hygroscopic structure includes a hygroscopic member and a delustering component. The hygroscopic member is arranged in the optical channel and connected to the channel wall of the optical channel to absorb moisture in the optical channel. The delustering component is arranged on the side of the hygroscopic member facing the optical channel.

In some of these embodiments, the hygroscopic member is bonded to the channel wall of the optical channel.

In some of the embodiments, the hygroscopic member and the extinction member are an integral component or a separate component.

In some embodiments, the optical channel has a first channel wall, a second channel wall, a third channel wall, and a fourth channel wall connected in sequence. The first channel wall and the third channel wall are arranged opposite to each other, and the second channel wall and the fourth channel wall are arranged opposite to each other. The hygroscopic structure is arranged on at least one of the first channel wall, the second channel wall, the third channel wall, and the fourth channel wall.

In some of the embodiments, two moisture-absorbing structures are respectively arranged on the first channel wall and the third channel wall, and an extinction structure is provided on the second channel wall and the fourth channel wall. The first channel wall and the third channel wall are arranged opposite to each other along the second direction.

In some of the embodiments, a mounting groove is provided on the channel wall of the optical channel, and the moisture absorption structure is arranged in the mounting groove.

In some of the embodiments, the extinction member is arranged at the groove opening of the mounting groove and connected to the groove side wall of the mounting groove, the hygroscopic member is connected to or spaced apart from the groove side wall of the mounting groove, and the hygroscopic member is connected to or spaced apart from the side of the extinction member away from the optical channel.

The embodiment of the present application also provides a LiDAR, including a housing, a light deflection scanning element, a transceiver module, and a window mirror assembly. The transceiver module and the light deflection scanning element are both arranged in the housing; the transceiver module generates an outgoing light beam and receives a reflected light beam; the light deflection scanning element deflects the outgoing light beam toward the window mirror assembly, and receives and deflects the reflected light beam returned from the measured area toward the transceiver module; and the window mirror assembly transmits the outgoing light beam and the reflected light beam.

An embodiment of the present application also provides an autonomous driving device, which includes a device body and a LiDAR installed on the device body.

The embodiment of the present application also provides an assembly process of a window mirror assembly, which is applicable to the window mirror assembly, and the assembly process includes:
installing a hygroscopic structure on the channel wall of the optical channel; injecting structural glue between the window mirror and the lens barrel so that the two window mirrors are sealed and connected to the two ends of the optical channel respectively; and controlling the negative pressure in the optical channel to eliminate bubbles in the structural glue.

In some embodiments, a connecting groove is formed at each end of the optical channel. The connecting groove includes a groove side wall, the groove side wall is further recessed to form a first glue dispensing groove and a second glue dispensing groove, the second glue dispensing groove is located at the notch position of the connecting groove, and the first glue dispensing groove is located at a side of the second glue dispensing groove away from the notch of the connecting groove. The steps of injecting structural glue between the window mirror and the lens barrel so that the two window mirrors are respectively sealed and connected to the two ends of the optical channel include:
injecting a first structural glue into the first glue dispensing groove so that the window mirror is fixed to the connecting groove to form a lens assembly;
heating the lens assembly and the second structural glue to a preset temperature; and
injecting the second structural glue into the second glue dispensing groove to ensure a sealing connection between the window mirror and the lens barrel.

In some embodiments, the step of controlling the negative pressure in the optical channel includes:
moving the window mirror assembly into a temperature box, where the temperature of the temperature box is controlled to decrease, so that the temperature in the optical channel decreases to form a negative pressure.

In some embodiments, a connecting groove is formed at each end of the optical channel. The connecting groove includes a groove side wall, the groove side wall is further recessed to form a first glue dispensing groove and a second glue dispensing groove, the second glue dispensing groove is located at the notch position of the connecting groove, and the first glue dispensing groove is located at a side of the second glue dispensing groove away from the notch of the connecting groove. The steps of injecting structural glue between the window mirror and the lens barrel so that the two window mirrors are respectively sealed and connected to the two ends of the optical channel include:
injecting a first structural glue into the first glue dispensing groove so that the window mirror is fixed to the connecting groove to form a lens assembly;
moving the lens assembly into the vacuum device; and
injecting the second structural glue into the second glue dispensing groove to ensure a sealing connection between the window mirror and the lens barrel.

In some embodiments, the step of controlling the negative pressure in the optical channel includes:
controlling the vacuum equipment to maintain vacuum so that negative pressure is maintained inside and outside the optical channel.

In some embodiments, the step of installing a hygroscopic structure on a channel wall of the optical channel includes:
bonding the hygroscopic member to the channel wall of the optical channel; and
arranging the extinction member on the side of the hygroscopic member facing the optical channel.

Based on the window mirror assembly of the present application, the moisture generated during the installation of the window mirror is absorbed by the hygroscopic member, and the moisture that penetrates into the optical channel through the window mirror and the lens barrel can also be absorbed, so as to reduce the probability of moisture turning into condensation and adhering to the inner wall of the window mirror, thereby reducing the influence of condensation on LiDAR detection. The extinction member can reduce the reflection and scattering of stray light generated by the outgoing light beam and the reflected light beam on the surface of the optical channel, so as to ensure that the LiDAR can have a higher detection accuracy.

### BRIEF DESCRIPTION OF DRAWINGS

In order to more clearly illustrate the embodiments of the present application or the technical solutions in the prior art, the drawings are briefly introduced below. Obviously, the drawings described below are only some embodiments of the present application. For those skilled in the art, other drawings can be obtained based on these drawings without any creative work.

FIG. 1 is a schematic diagram of the structure of a LiDAR in one embodiment of the present application;

FIG. 2 is a schematic diagram of the structure of a window mirror assembly in one embodiment of the present application;

FIG. 3 is a schematic diagram of the exploded structure of the window mirror assembly in one embodiment of the present application;

FIG. 4 is an enlarged schematic diagram of the structure at A in FIG. 3;

FIG. 5 is a flowchart of the assembly process of the window mirror assembly in one embodiment of the present application;

FIG. 6 is a flowchart of the assembly process of the window mirror assembly in another embodiment of the present application;

FIG. 7 is a flowchart of the assembly process of the window mirror assembly in another embodiment of the present application;

FIG. 8 is a flowchart of the assembly process of the window mirror assembly in another embodiment of the present application;

FIG. 9 is a flowchart of the assembly process of the window mirror assembly in another embodiment of the present application; and

FIG. 10 is a flow chart of an assembly process of a window mirror assembly in yet another embodiment of the present application.

Explanation of the reference numerals: 1. LiDAR; 11. housing; 12. window mirror assembly; 121. lens barrel; 121A. optical channel; 121B. mounting groove; 121C. connecting groove; 121D. first glue dispensing groove; 121E. second glue dispensing groove; 122. window mirror; 123. hygroscopic structure; 1231. hygroscopic member; 1232. matting component; 124. extinction structure; 124A. matting groove; 125. first structural glue; 126. second structural glue; X, first direction; Y, second direction.

### DETAILED DESCRIPTION

In order to make the purpose, technical solution, and advantages of this application clearer, the following is a further detailed description of this application in conjunction with the accompanying drawings and embodiments. It should be understood that the embodiments described here are only used to explain this application and are not used to limit this application.

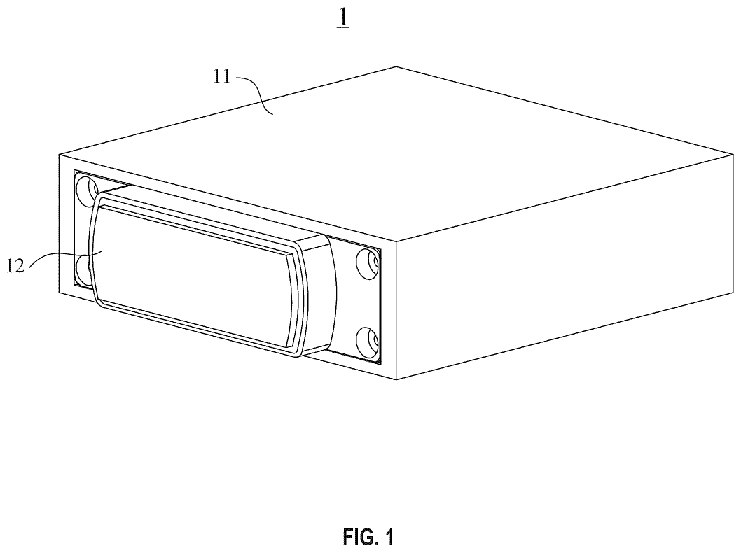

In the first aspect, please refer to FIG. 1. An embodiment of the present application provides a LiDAR 1, including a housing 11, a light deflection scanning element (not shown in the figure), a transceiver module (not shown in the figure) and a window mirror assembly 12; the transceiver module and the light deflection scanning element are both arranged in the housing 11.

The housing 11 is used to protect the internal transceiver module and the light deflection scanning element, reduce the probability of damage to the transceiver module and the light deflection scanning element, so that the transceiver module and the light deflection scanning element can have a longer life, thereby allowing the LiDAR 1 to have a longer service life. In some embodiments, the material of the housing 11 can be metal or plastic. In the present application, there is no specific limitation on the material of the housing 11.

The transceiver module is used to generate an outgoing light beam, and emit it to the measured area through the light deflection scanning element and the window mirror assembly 12. The transceiver module is also used to receive the reflected light beam returned from the measured area through the window mirror assembly 12 and the light deflection scanning element, so as to obtain relevant information of the target, such as target distance, direction, height, speed, posture, and even shape parameters.

The light deflection scanning element is used to reflect the outgoing light beam and the reflected light beam transmitted through the window mirror 122. The light deflection scanning element includes but is not limited to an optical scanning mirror and a MEMS galvanometer (Micro-Electro-Mechanical System).

The window mirror assembly 12 is used to transmit the outgoing light beam and the reflected light beam. In some embodiments, the window mirror assembly 12 may include an angle-expanding lens, which can increase the outgoing angle of the outgoing light beam to increase the field of view of the LiDAR 1, thereby increasing the detection range of the LiDAR 1 and improving the detection efficiency of the LiDAR 1.

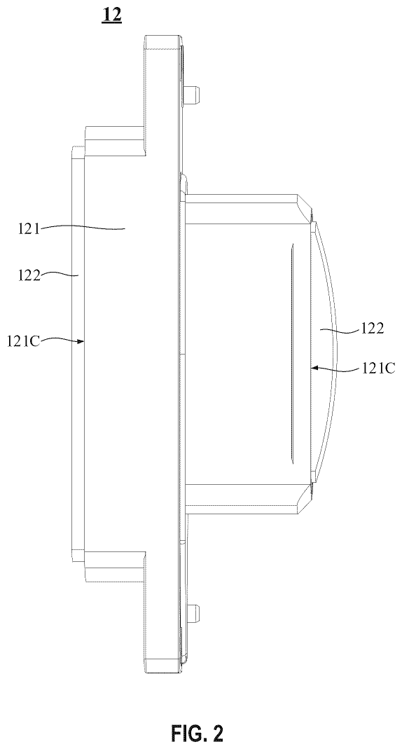

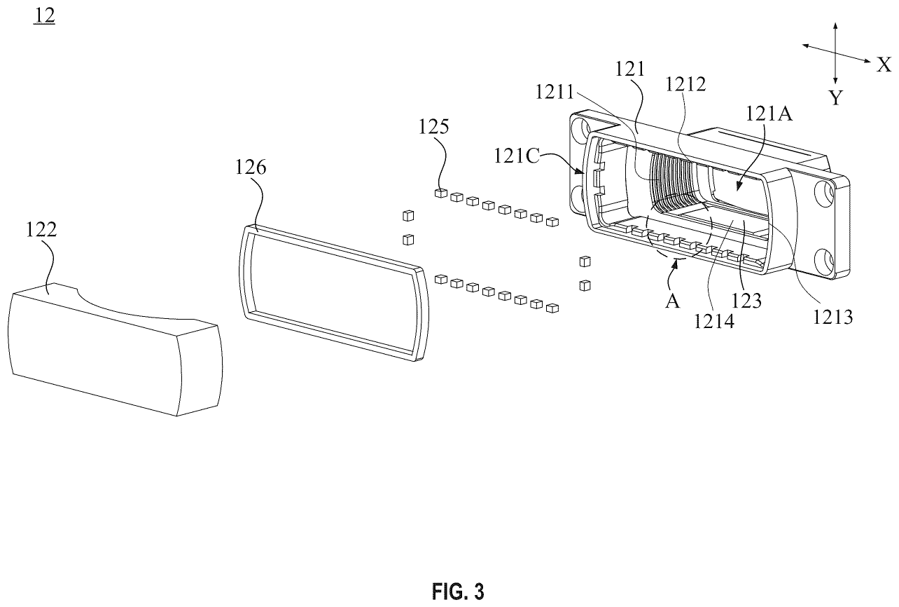

Please refer to FIGS. 1-4. In one embodiment, the window mirror assembly 12 includes a lens barrel 121, two window mirrors 122, and a hygroscopic structure 123. The lens barrel 121 has an optical channel 121A. The two window mirrors 122 are respectively located at the two ends of the optical channel 121A and are both sealed and connected to the lens barrel 121. The hygroscopic structure 123 includes a hygroscopic member 1231, and the hygroscopic member 1231 is connected to the channel wall of the optical channel 121A. The hygroscopic member 1231 can be used to absorb moisture generated during the installation of the window mirrors 122, and can also absorb moisture that penetrates into the optical channel 121A through the window mirrors 122 and the lens barrel 121 during use. This reduces the probability of moisture turning into condensation and adhering to the inner wall of the window mirror 122 when the ambient temperature of the window mirror assembly 12 increases and then decreases, thereby reducing the influence of condensation on the detection of the LiDAR 1, and ensuring that the LiDAR 1 maintains a higher detection accuracy. Exemplarily, the window mirror 122 can be an angle-expanding lens to increase the field of view of the LiDAR 1, thereby increasing the detection range of the LiDAR 1, and improving the detection efficiency of the LiDAR 1.

It is understandable that the hygroscopic member 1231 can be made of a material with good hygroscopic properties, such as a water-absorbing polymer, etc. In the present application, there is no specific limitation on the shape and size of the hygroscopic member 1231. In other embodiments, the shape and size of the hygroscopic member 1231 can be designed according to the specific requirements of the optical channel 121A to ensure that the hygroscopic member 1231 can meet the hygroscopic requirements of the optical channel 121A.

Please refer to FIGS. 1-4. Further, the hygroscopic structure 123 can also include a delustering extinction member 1232. The delustering extinction member 1232 is arranged on the side of the hygroscopic member 1231 facing the optical channel 121A, so that the delustering extinction member 1232 can reduce the reflection and scattering of stray light generated by the outgoing light beam and the reflected light beam on the surface of the optical channel 121A, thereby reducing the influence of the stray light on the detection accuracy of the LiDAR 1.

It is understandable that the extinction member 1232 can be made of a special material with tiny holes and a translucent surface layer, which can effectively reduce the reflection and scattering of light on the surface of the optical channel 121A. The shape and size of the extinction member 1232 are designed according to the hygroscopic member 1231 to ensure that it can fit closely on the surface of the hygroscopic member 1231, thereby effectively eliminating stray light in the optical channel 121A, providing reliable guarantee for the high detection accuracy of the LiDAR 1.

It is understandable that in order to reduce the effect of the extinction member 1232 on the moisture absorption of the optical channel 121A by the hygroscopic member 1231, the extinction member 1232 can be a water-permeable extinction member so that the moisture in the optical channel 121A can pass through the extinction member 1232 and be absorbed by the hygroscopic member 1231.

Furthermore, the hygroscopic member 1231 can be installed on the channel wall of the optical channel 121A by bonding or heat pressing; and the extinction member 1232 can be connected to the surface of the hygroscopic member 1231 facing the optical channel 121A by bonding or heat pressing.

In some embodiments, the hygroscopic member 1231 can also be connected to the channel wall of the optical channel 121A by means of snap connection or screw connection. In the present application, there is no specific limitation on the connection method between the hygroscopic member 1231 and the channel wall of the optical channel 121A.

It can be understood that the hygroscopic member 1231 and the extinction member 1232 can also be an integrated component, so that the hygroscopic structure 123 can be installed in one installation step. Compared with installing the hygroscopic member 1231 and the extinction member 1232 separately, the installation steps of the hygroscopic structure 123 can be reduced to improve the installation efficiency of the hygroscopic structure 123, thereby improving the assembly efficiency of the window mirror assembly 12.

Please refer to FIGS. 1-4. In one embodiment, the optical channel 121A has a first channel wall 1211, a second channel wall 1212, a third channel wall 1213, and a fourth channel wall 1214 connected in sequence, the first channel wall and the third channel wall are arranged opposite to each other, and the second channel wall and the fourth channel wall are arranged opposite to each other. The hygroscopic structure 123 is arranged on at least one of the first channel wall, the second channel wall, the third channel wall, and the fourth channel wall, so that the hygroscopic structure 123 can absorb moisture in the optical channel 121A.

Please refer to FIGS. 1-4. The window mirror assembly 12 may include two hygroscopic structures 123. Since the divergence angle of the light beam entering the window mirror assembly 12 along the first direction X is greater than the divergence angle along the second direction Y, where the first direction X and the second direction Y are perpendicular to each other, the two hygroscopic structures 123 may be respectively arranged on the first channel wall and the third channel wall, and the second channel wall and the fourth channel wall are provided with an extinction structure 124. The first channel wall and the third channel wall are arranged opposite to each other along the second direction Y, and the second channel wall and the fourth channel wall are arranged along the first direction X, so that the extinction structure 124 can better absorb the stray light of a larger angle generated by the light beam along the first direction X, and the extinction member 1232 can absorb the stray light of a smaller angle generated by the light beam along the second direction Y, which not only ensures that the hygroscopic structure 123 can effectively dehumidify the inside of the lens barrel 121, but also improve the absorption effect of the stray light, thereby reducing the influence of the stray light on the detection accuracy of the LiDAR 1.

Exemplarily, the extinction structure 124 may include but is not limited to a structured aperture, an extinction material layer, a groove structure, and a rough surface structure.

In some embodiments, the extinction material layer can be formed by ink coating, extinction paint coating, light-absorbing film coating, glue dispensing, etc. In addition, physical structural forms such as the groove structure and the rough surface structure can form a multiple reflection process, thereby effectively reducing the formation of stray light.

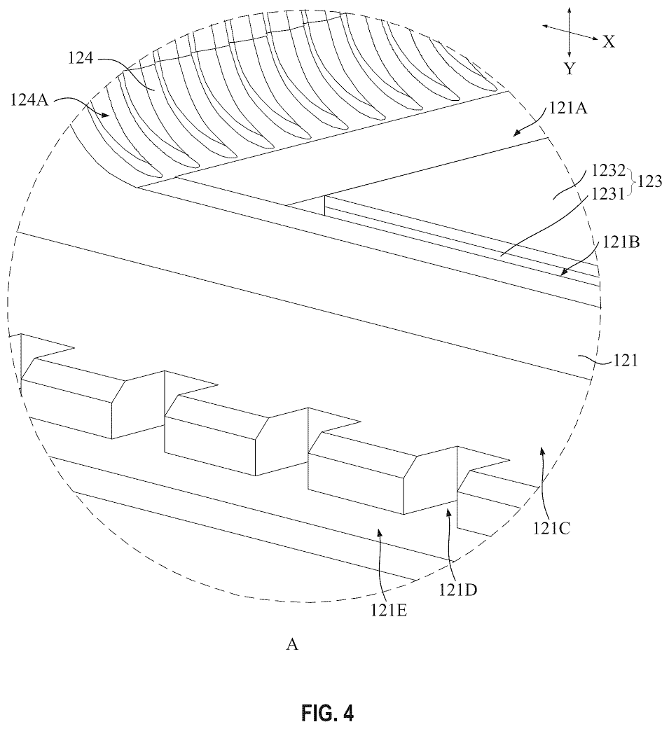

Please refer to FIG. 4. In some embodiments of the present application, the extinction structure 124 may include a plurality of extinction grooves 124A, and the plurality of extinction grooves 124A are all arranged on the channel wall of the optical channel 121A, and two adjacent extinction grooves 124A are arranged at intervals along the length direction of the channel wall of the optical channel 121A, so that stray light can form a process of multiple reflections in the extinction grooves 124A to absorb the stray light in the optical channel 121A.

It can be understood that the extinction structure 124 can also be set on the first channel wall and the third channel wall, and the two hygroscopic structures 123 can also be respectively set on the second channel wall and the fourth channel wall, and can also absorb stray light on the basis of absorbing moisture in the optical channel 121A, so as to reduce the influence of stray light on the detection accuracy of the LiDAR 1.

It can be understood that the window mirror assembly 12 may include four hygroscopic structures 123, and the four hygroscopic structures 123 are respectively arranged on the first channel wall, the second channel wall, the third channel wall, and the fourth channel wall, so that the hygroscopic structure 123 can be arranged around the channel wall of the optical channel 121A, and can absorb stray light on the basis of absorbing moisture in the optical channel 121A, thereby ensuring that the LiDAR 1 can have a higher detection accuracy.

Please refer to FIGS. 1, 3, and 4. In one embodiment, a mounting groove 121B is provided on the channel wall of the optical channel 121A, and the hygroscopic structure 123 is arranged in the mounting groove 121B to reduce the protruding height of the hygroscopic structure 123 in the optical channel 121A, thereby reducing the influence of the hygroscopic structure 123 on the outgoing light beam and the reflected light beam, thereby ensuring that the LiDAR 1 can have a higher detection accuracy.

In some embodiments, the extinction member 1232 is disposed at the groove opening of the mounting groove 121B and connected to the groove sidewall of the mounting groove 121B, so that the extinction member 1232 can completely cover the groove opening of the mounting groove 121B, thereby preventing the sidewall of the mounting groove 121B from reflecting stray light, thereby providing a reliable guarantee for the high detection accuracy of the LiDAR 1. Exemplarily, the extinction member 1232 can be connected to the groove sidewall of the mounting groove 121B by bonding or hot pressing.

Furthermore, in order to improve the hygroscopic performance of the hygroscopic member 1231, the hygroscopic member 1231 can be connected to the bottom of the mounting groove 121B and spaced from the groove side wall of the mounting groove 121B, so that the peripheral side of the hygroscopic member 1231 can contact the air in the optical channel 121A, so as to increase the contact area between the hygroscopic member 1231 and the air in the optical channel 121A, thereby improving the hygroscopic performance of the hygroscopic member 1231 and improving the absorption efficiency of the hygroscopic member 1231 on moisture in the optical channel 121A, so as to reduce the probability of moisture turning into condensation and adhering to the inner wall of the window mirror 122, thereby reducing the influence of condensation on the detection of the LiDAR 1 and ensuring that the LiDAR 1 can have a higher detection accuracy.

Furthermore, the hygroscopic member 1231 can also be spaced apart from the side of the extinction member 1232 away from the mounting groove 121B, so that the hygroscopic member 1231 can also contact the air in the optical channel 121A toward the extinction member 1232 to absorb moisture in the optical channel 121A, thereby further increasing the contact area between the hygroscopic member 1231 and the air in the optical channel 121A and improving the hygroscopic performance of the hygroscopic member 1231.

It can be understood that the hygroscopic member 1231 can be connected to the side wall of the mounting groove 121B, and the hygroscopic member 1231 can also be connected to the side of the extinction member 1232 away from the mounting groove 121B, both of which enable the hygroscopic member 1231 to absorb moisture in the optical channel 121A to reduce the probability of moisture turning into condensation and adhering to the inner wall of the window mirror 122, thereby ensuring that the LiDAR 1 can have a higher detection accuracy.

Please refer to FIGS. 1, 3, and 4, in some embodiments, a connecting groove 121C is formed at each end of the optical channel 121A, and two window mirrors 122 are respectively embedded in the two connecting grooves 121C to ensure a stable connection between the window mirrors 122 and the lens barrel 121.

Please refer to FIGS. 1, 3, and 4. Further, the connecting groove 121C includes a groove side wall, and the groove side wall is further recessed to form a plurality of first glue dispensing grooves 121D and a second glue dispensing groove 121E. The second glue dispensing groove 121E is arranged at the groove position of the connecting groove 121C. The plurality of first glue dispensing grooves 121D are all connected to the second glue dispensing groove 121E, and the plurality of first glue dispensing grooves 121D are all arranged on the side of the second glue dispensing groove 121E away from the groove of the connecting groove 121C. The plurality of first glue dispending grooves 121D are arranged at circumferential intervals along the connecting groove 121C. Among them, the first glue dispensing groove 121D and the second glue dispensing groove 121E can be filled with structural glue of the same component or structural glue of different components. The structural glue in the first glue dispensing groove 121D can realize the pre-positioning between the window mirror 122 and the lens barrel 121, and the structural member in the second glue dispensing groove 121E can realize the sealed connection between the window mirror 122 and the lens barrel 121, so as to reduce the probability of impurities, liquids, and moisture entering the optical channel 121A through the notch of the connecting groove 121C, thereby reducing the influence of impurities, liquids, and moisture on the detection accuracy of the LiDAR 1. Additionally, it can also prevent impurities, liquids, and moisture from entering the LiDAR 1 through the optical channel 121A, thereby reducing the probability of damage to the optical deflection scanning element and the transceiver module, so that the LiDAR 1 can have a longer service life.

In the second aspect, an embodiment of the present application provides an automatic driving device, which includes a device body and a LiDAR 1 installed on the device body. The specific structure of the LiDAR 1 refers to the above embodiment. Since the automatic driving device adopts all the technical features of the LiDAR as described before, it at least has all the beneficial effects brought by the technical features of the aforementioned LiDAR, which is not repeated here. Among them, the automatic driving device can be a car, a ship, an aircraft, etc., without limitation.

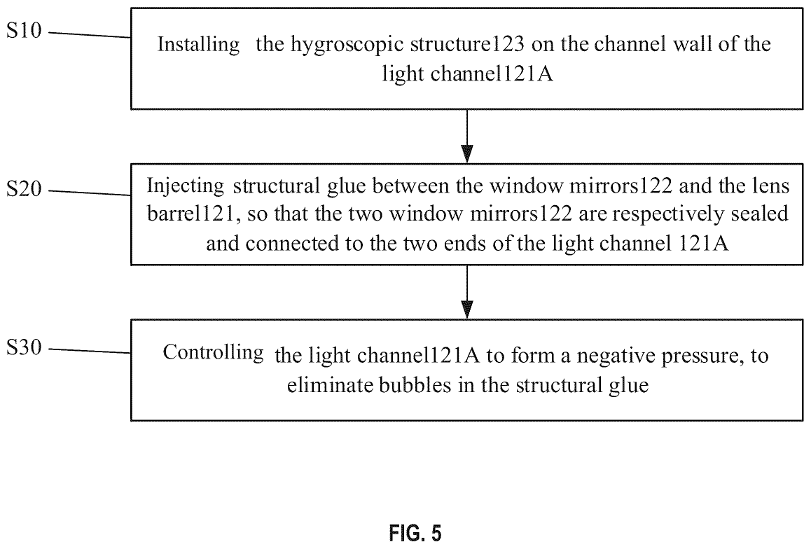

In the third aspect, referring to FIGS. 1-5, an embodiment of the present application further provides an assembly process of a window mirror assembly, which is applicable to the window mirror assembly 12, and the assembly process includes:

Step S10: installing the hygroscopic structure 123 on the channel wall of the optical channel 121A.

In an embodiment, a lens barrel 121 and a hygroscopic structure 123 are prepared, and the hygroscopic structure 123 is installed on the channel wall of the optical channel 121A by bonding or hot pressing. The hygroscopic structure 123 is used to absorb moisture generated in the optical channel 121A during the installation of the window mirror 122 and during the use of the LiDAR 1, so as to prevent moisture from condensing on the surface of the window mirror 122 facing the optical channel 121A, thereby ensuring that the LiDAR 1 has a higher detection accuracy.

Step S20: injecting structural glue between the window mirror 122 and the lens barrel 121, so that the two window mirrors 122 are respectively sealed and connected to the two ends of the optical channel 121A.

In an embodiment, structural glue is injected between the window mirror 122 and the lens barrel 121 so that the window mirrors 122 at both ends can be sealed and connected in the connecting groove 121C, so as to reduce the probability of impurities, liquids, and moisture entering the optical channel 121A through the notch of the connecting groove 121C, thereby reducing the influence of impurities, liquids, and moisture on the detection accuracy of the LiDAR 1.

Step S30: controlling the optical channel 121A to form a negative pressure to eliminate bubbles in the structural glue.

In an embodiment, negative pressure is controlled to form in the optical channel 121A so that bubbles in the structural glue can overflow, thereby eliminating bubbles generated during the solidification process of the structural glue, ensuring good air tightness between the window mirror 122 and the lens barrel 121, reducing the probability of moisture entering the optical channel 121A, and ensuring that the LiDAR 1 has high detection accuracy.

If the optical channel 121A is higher than the external air pressure, during the solidification process of the structural glue, the internal air pressure of the optical channel 121A is likely to cause the structural glue to overflow from the optical channel 121A, so as to form a bulge on the outside of the lens barrel 121, affecting the appearance of the lens barrel 121 and also affecting the appearance of the LiDAR 1. The bulge formed by the overflow of the structural glue from the optical channel 121A is likely to push the window mirror 122 out of the lens barrel 121, so that the window mirror 122 deviates from the preset position, resulting in lower detection accuracy of the LiDAR 1. The bulge formed by the overflow of the structural glue from the optical channel 121A is also likely to cause a gap between the window mirror 122 and the lens barrel 121, resulting in external moisture easily entering the optical channel 121A only through the gap. When the ambient temperature of the window mirror assembly 12 increases and then decreases, the moisture is likely to turn into condensation and adhere to the inner wall of the window mirror 122, resulting in reduced detection accuracy of the LiDAR 1.

It is understandable that after step S30, the bubbles in the structural glue can also be detected by appearance inspection and bubble detection equipment, so that after meeting the production requirements, the window mirror assembly 12 can be tested for air tightness by air tightness detection equipment to ensure that the window mirror assembly 12 produced by the above assembly process meets the production requirements. In the present application, the specific form of the bubble detection equipment and the air tightness detection equipment is not limited. In some embodiments, bubble detection can also be performed in other ways, such as visual inspection.

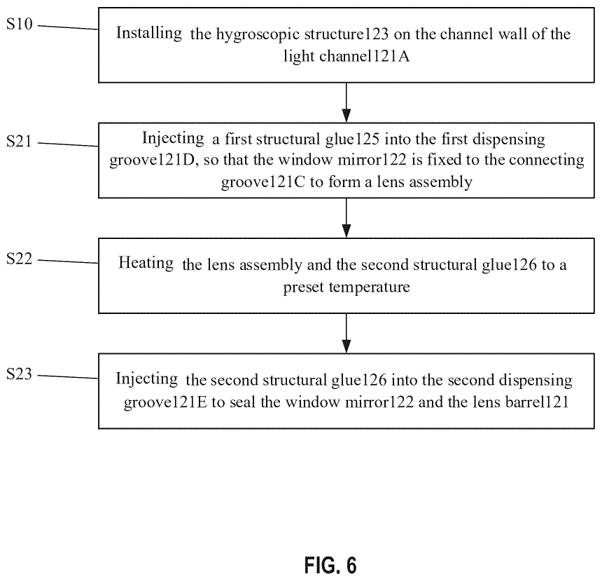

Refer to FIGS. 1-4 and 6, in one embodiment, step S20 includes:

Step S21, injecting the first structural glue 125 into the first glue dispensing groove 121D, so that the window mirror 122 is fixed to the connecting groove 121C to form a lens assembly.

In the embodiment of the present application, the first structural glue 125 is injected into the first glue dispensing groove 121D by a glue dispensing device. The window mirror 122 is moved such that the window mirror 122 is embedded in the connecting groove 121C, and the first structural glue 125 is brought into contact with the window mirror 122, thereby pre-fixing the window mirror 122 and the lens barrel 121. As a result, the two window mirrors 122 and the lens barrel 121 form a lens assembly.

Step S22: heating the lens assembly and the second structural glue 126 to a preset temperature.

In the embodiment of the present application, the lens assembly is moved into the heating device, and the heating device is controlled to heat the lens assembly to a preset temperature, such that the internal gas of the optical channel 121A expands, allowing part of the gas in the optical channel 121A to be discharged through the gap between the window mirror 122 and the lens barrel 121. Meanwhile, the dispensing device is controlled to heat the second structural glue 126 to a preset temperature, such that when the second structural glue 126 contacts the lens barrel 121 and the window mirror 122, the curing rate of the second structural glue 126 is low, allowing the second structural glue 126 to have good fluidity, thereby enabling the second structural glue 126 to fill the gap between the lens barrel 121 and the window mirror 122, thereby increasing the contact area between the lens barrel 121 and the window mirror 122 and the second structural glue 126, thereby improving the connection stability between the lens barrel 121 and the window mirror 122. This also enables a sealed connection between the lens barrel 121 and the window mirror 122, thereby reducing the probability of moisture entering the optical channel 121A, preventing moisture from condensing on the surface of the window mirror 122 facing the optical channel 121A, and ensuring that the LiDAR 1 maintains a higher detection accuracy.

For example, the preset temperature may be 30° C., 40° C., 50° C., 60° C., 70° C., etc. In the embodiment of the present application, the lens assembly is heated to the preset temperature, such that the second structural glue 126 can have good fluidity without affecting the performance and service life of the window mirror 122. In other embodiments, the preset temperature can be selected according to structural glues of different components and different sealing requirements.

Step S23, injecting the second structural glue 126 into the second glue dispensing groove 121E to ensure that the window mirror 122 and the lens barrel 121 are sealed and connected.

In the embodiment of the present application, the glue dispensing device is controlled to inject the second structural glue 126 at a preset temperature into the second glue dispensing groove 121E, and the second structural glue 126 is evenly distributed in the second glue dispensing groove 121E, thereby increasing the contact area between the second structural glue 126 and the lens barrel 121 and the window mirror 122, thereby improving the connection stability between the lens barrel 121 and the window mirror 122. This also enables a sealed connection between the lens barrel 121 and the window mirror 122, thereby reducing the probability of moisture entering the optical channel 121A, preventing moisture from condensing on the surface of the window mirror 122 facing the optical channel 121A, and ensuring that the LiDAR 1 maintains a higher detection accuracy.

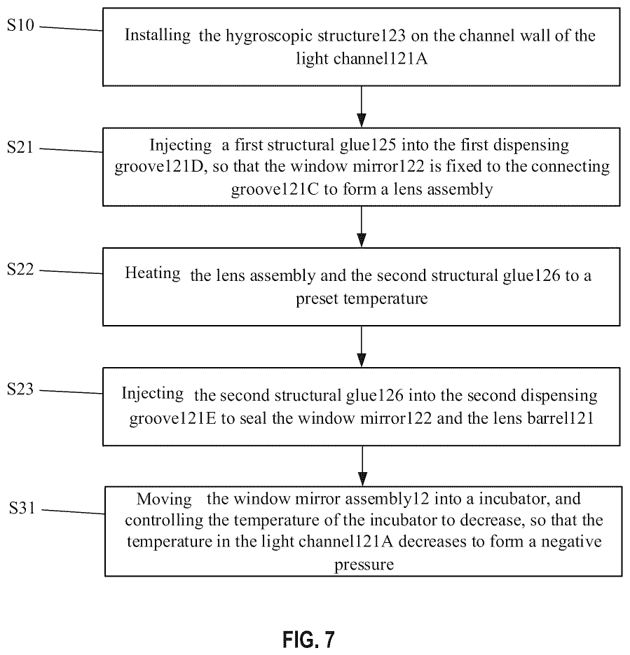

Refer to FIGS. 1-4 and 7, in one embodiment, step S30 includes:

Step S31, moving the window mirror assembly 12 into the temperature box, controlling the temperature of the temperature box to decrease, so that the temperature in the optical channel 121A decreases to form a negative pressure.

In the embodiment of the present application, the window mirror assembly 12 is moved to the temperature box, and the temperature box controls the cooling rate of the window mirror assembly 12, such that the air in the optical channel 121A shrinks evenly to form a negative pressure in the optical channel 121A, thereby preventing the first structural glue 125 and the second structural glue 126 from overflowing and forming bubbles during the solidification process. As a result, the sealed connection between the window mirror 122 and the lens barrel 121 is stable, and the probability of moisture entering the optical channel 121A is reduced, thus preventing moisture from condensing on the surface of the window mirror 122 facing the optical channel 121A, thereby ensuring that the LiDAR 1 maintains a high detection accuracy.

In the present application, there is no specific restriction on the cooling rate of the window mirror assembly 12 controlled by the temperature box. In other embodiments, according to the number of bubbles in the first structural glue 125 and the second structural glue 126, as well as the compositions and curing time of the first structural glue 125 and the second structural glue 126, a suitable negative pressure intensity and negative pressure duration, and a suitable cooling rate can be adaptively selected.

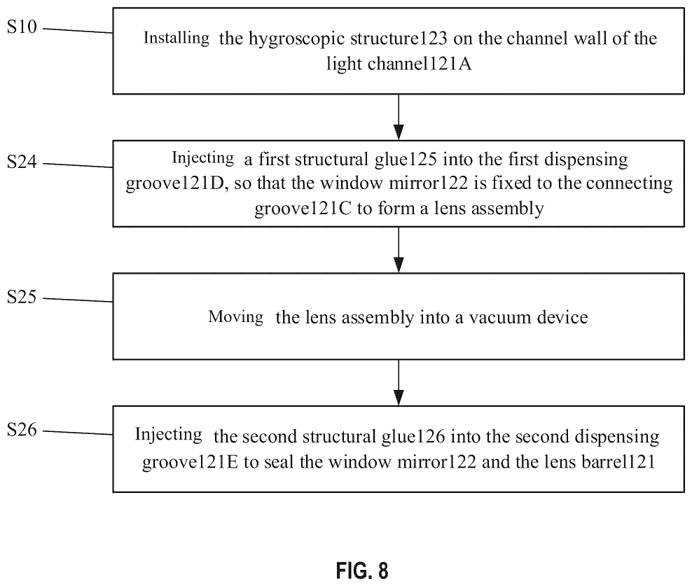

Refer to FIGS. 1-4 and 8, in one embodiment, step S20 may further include:

Step S24: injecting the first structural glue 125 into the first glue dispensing groove 121D so that the window mirror 122 is fixed to the connecting groove 121C to form a lens assembly.

In the embodiment of the present application, the first glue dispensing device is controlled to inject the first structural glue 125 into the first glue dispensing groove 121D, the window mirror 122 is moved such that the window mirror 122 is embedded in the connecting groove 121C. The first structural glue 125 remains in contact with the window mirror 122 until the first structural glue 125 solidifies, thereby the window mirror 122 and the lens barrel 121 are pre-fixed, such that the two window mirrors 122 and the lens barrel 121 form a lens assembly.

Step S25, moving the lens assembly into the vacuum equipment.

In the embodiment of the present application, the lens assembly is moved into a vacuum device, and the vacuum device is started to form a vacuum environment in the vacuum device, such that the optical channel 121A is also a vacuum environment.

Step S26, injecting the second structural glue 126 into the second glue dispensing groove 121E, such that the two window mirrors 122 are sealed and connected to the lens barrel 121.

In the embodiment of the present application, the second structural glue 126 is injected into the second glue dispensing groove 121E by the second glue dispensing device in the vacuum device, and the second structural glue 126 is evenly distributed in the second glue dispensing groove 121E, thereby increasing the contact area between the second structural glue 126 and the lens barrel 121 and the window mirror 122, such that when the window mirror 122 is connected to the lens barrel 121 through the second structural glue 126, the connection between the window mirror 122 and the lens barrel 121 is stable.

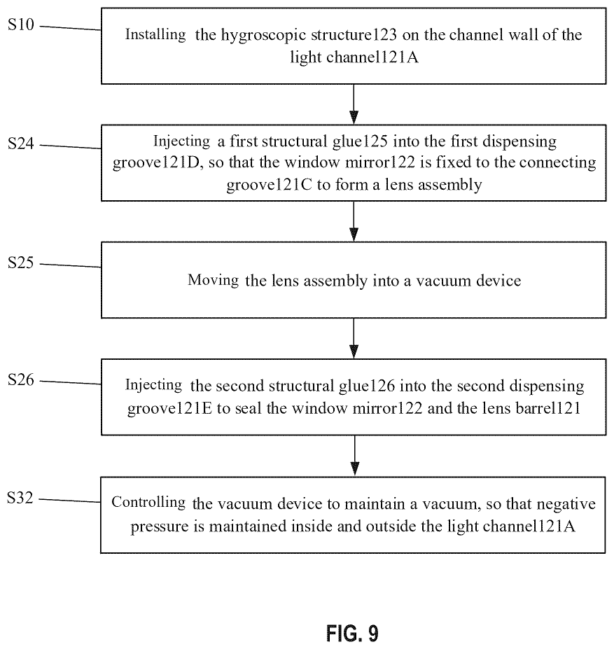

Refer to FIGS. 1-4 and 9, in one embodiment, step S30 may further include:

Step S32: controlling the vacuum equipment to maintain the vacuum, such that negative pressure is maintained inside and outside the optical channel 121A.

In the embodiment of the present application, the vacuum device is controlled to maintain the vacuum, and the negative pressure strength and negative pressure duration of the vacuum device are controlled to prevent the first structural glue 125 and the second structural glue 126 from overflowing and forming bubbles during the solidification process. As a result, the sealed connection between the window mirror 122 and the lens barrel 121 is stable, and the probability of moisture entering the optical channel 121A is reduced, thereby preventing moisture from condensing on the surface of the window mirror 122 facing the optical channel 121A, and ensuring that the LiDAR 1 maintains a high detection accuracy.

In the embodiment of the present application, the negative pressure strength and negative pressure duration of the vacuum device are not subject to specific restrictions. In other embodiments, appropriate negative pressure strength and negative pressure duration can be adaptively selected according to the number of bubbles in the first structural glue 125 and the second structural glue 126, as well as the composition and curing time of the first structural glue 125 and the second structural glue 126.

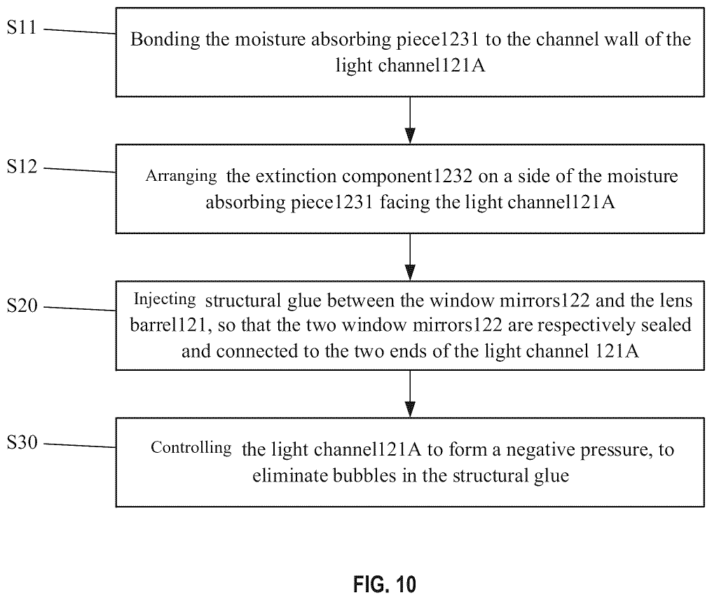

Refer to FIGS. 1-4 and 10, in one embodiment, step S10 includes:

Step S11, bonding the hygroscopic member 1231 to the channel wall of the optical channel 121A.

In the embodiment of the present application, after the lens barrel 121 and the hygroscopic structure 123 are prepared, the hygroscopic member 1231 is bonded to the channel wall of the optical channel 121A, and a first preset force is applied to the hygroscopic member 1231 for a first preset time until the hygroscopic member 1231 is stably bonded to the channel wall of the optical channel 121A, thereby reducing the probability of the hygroscopic member 1231 being separated from the channel wall of the optical channel 121A, and preventing the detached hygroscopic member 1231 from blocking the optical channel 121A, thus ensuring that the LiDAR 1 operates properly. In the embodiment of the present application, there is no specific limitation on the first preset time and the magnitude of the first preset force.

It can be understood that when a mounting groove 121B is formed on the channel wall of the optical channel 121A, the hygroscopic member 1231 is bonded to the bottom of the mounting groove 121B, and a first preset force is applied to the hygroscopic member 1231 for a first preset time until the hygroscopic member 1231 is stably bonded to the bottom of the mounting groove 121B, thereby reducing the probability of the hygroscopic member 1231 being detached from the bottom of the mounting groove 121B, preventing the detached hygroscopic member 1231 from blocking the optical channel 121A, and ensuring that the LiDAR 1 can operate normally.

Step S12: disposing the extinction member 1232 on the side of the hygroscopic member 1231 facing the optical channel 121A.

In the embodiment of the present application, the extinction member 1232 is bonded to the surface of the hygroscopic member 1231 facing the optical channel 121A, and a second preset force is applied to the extinction member 1232 for a second preset time until the extinction member 1232 is stably bonded to the surface of the hygroscopic member 1231 facing the optical channel 121A, thereby reducing the probability of the extinction member 1232 being separated from the hygroscopic member 1231, preventing the separated extinction member 1232 from blocking the optical channel 121A, and ensuring that the LiDAR 1 operates properly. In the embodiment of the present application, there is no specific limitation on the second preset time and the magnitude of the second preset force.

In other embodiments, the extinction member 1232 is moved to the groove opening of the mounting groove 121B, and a second preset force is applied to the extinction member 1232 for a second preset time period until the extinction member 1232 is stably bonded to the groove side wall of the mounting groove 121B, such that the extinction member 1232 may completely cover the groove opening of the mounting groove 121B, thereby preventing the side wall of the mounting groove 121B from reflecting stray light, and providing reliable guarantee for the higher detection accuracy of the LiDAR 1.

The same or similar numbers in the drawings of this embodiment correspond to the same or similar parts. In the description of this application, it should be understood that if the terms “upper,” “lower,” “left,” “right,” and the like indicate directions or positional relationships based on the directions or positional relationships shown in the drawings, it is only for the convenience of describing this application and simplifying the description, rather than indicating or implying that the device or element referred to must have a specific direction, be constructed and operated in a specific direction. Therefore, the terms describing the positional relationship in the drawings are only used for illustrative purposes and cannot be understood as a limitation on the present application. For ordinary technicians in this field, the specific meanings of the above terms can be understood according to specific circumstances.

The above are only exemplary embodiments of the present application and are not intended to limit the present application. Any modifications, equivalent substitutions, and improvements made within the spirit and principles of the present application should be included in the protection scope of the present application.

What is claimed is:

1. A window mirror assembly, applied to a LiDAR, comprising:
a lens barrel with an optical channel;
two window mirrors, respectively located at two ends of the optical channel, both sealed and connected to the lens barrel; and
a hygroscopic structure, comprising:
a hygroscopic member, disposed in the optical channel and connected to a channel wall of the optical channel, configured to absorb moisture in the optical channel; and
an extinction member, arranged on a side of the hygroscopic member facing the optical channel.

2. The window mirror assembly according to claim 1, wherein the hygroscopic member is bonded to the channel wall of the optical channel.

3. The window mirror assembly according to claim 1, wherein the hygroscopic member and the extinction member are an integral component or a separate component.

4. The window mirror assembly according to claim 1, wherein the optical channel has a first channel wall, a second channel wall, a third channel wall, and a fourth channel wall connected in sequence, the first channel wall is arranged opposite to the third channel wall, and the second channel wall is arranged opposite to the fourth channel wall; and
the hygroscopic structure is arranged on at least one of the first channel wall, the second channel wall, the third channel wall, and the fourth channel wall.

5. The window mirror assembly according to claim 4, wherein the number of the hygroscopic structures is two, the two hygroscopic structures are respectively arranged on the first channel wall and the third channel wall, and the second channel wall and the fourth channel wall are provided with extinction structures,
wherein the first channel wall and the third channel wall are opposite to each other along a second direction.

6. The window mirror assembly according to claim 1, wherein the channel wall of the optical channel has a mounting groove, and the hygroscopic structure is arranged in the mounting groove.

7. The window mirror assembly according to claim 6, wherein the extinction member is arranged at a notch of the mounting groove and connected to a side wall of the mounting groove; and
the hygroscopic member is connected to or spaced apart from the side wall of the mounting groove, and the hygroscopic member is connected to or spaced apart from extinction member.

8. A LIDAR, comprising a housing, a light deflection scanning element, a transceiver module, and the window mirror assembly according to claim 1, wherein
the transceiver module and the light deflection scanning element are both arranged in the housing;
the transceiver module is configured to generate an outgoing light beam and receives a reflected light beam;
the light deflection scanning element is configured to deflect the outgoing light beam toward the window mirror assembly, and receive and deflect the reflected light beam returned from a measured area toward the transceiver module; and
the window mirror assembly is configured to transmit the outgoing light beam and the reflected light beam.

9. An assembly process of the window mirror assembly according to claim 1, comprising:
installing the hygroscopic structure on the channel wall of the optical channel;
injecting structural glue between the two window mirrors and the lens barrel, such that the two window mirrors are respectively sealed and connected to the two ends of the optical channel; and
controlling the optical channel to form a negative pressure, to eliminate bubbles in the structural glue.

10. The assembly process according to claim 9, wherein a connecting groove is formed at each end of the optical channel, the connecting groove includes a groove side wall, the groove side wall is further recessed to form a first dispensing groove and a second dispensing groove, the second dispensing groove is located at a notch of the connecting groove, and the first dispensing groove is located on the side of the second dispensing groove away from the notch of the connecting groove,
wherein injecting the structural glue between the two window mirrors and the lens barrel comprising:
injecting a first structural glue into the first dispensing groove, such that the two window mirrors are fixed to the connecting groove to form a lens assembly;
heating the lens assembly and a second structural glue to a preset temperature; and
injecting the second structural glue into the second dispensing groove to seal the two window mirrors and the lens barrel.

11. The assembly process according to claim 10, wherein controlling the optical channel to form the negative pressure comprising:
moving the window mirror assembly into an incubator, and controlling a temperature of the incubator to decrease, such that the temperature in the optical channel decreases to form the negative pressure.

12. The assembly process according to claim 9, wherein a connecting groove is formed at each end of the optical channel, the connecting groove includes a groove side wall, the groove side wall is further recessed to form a first dispensing groove and a second dispensing groove, the second dispensing groove is located at a notch of the connecting groove, and the first dispensing groove is located on the side of the second dispensing groove away from the notch of the connecting groove,
wherein injecting the structural glue between the two window mirrors and the lens barrel comprising:
injecting a first structural glue into the first dispensing groove, such that the two window mirrors are fixed to the connecting groove to form a lens assembly;
moving the lens assembly into a vacuum device; and
injecting a second structural glue into the second dispensing groove to seal the two window mirrors and the lens barrel.

13. The assembly process according to claim 12, wherein controlling the optical channel to form the negative pressure comprising:
controlling the vacuum device to maintain a vacuum, such that the negative pressure is maintained inside and outside the optical channel.

14. The assembly process according to claim 9, wherein installing the hygroscopic structure on the channel wall of the optical channel comprises:
bonding the hygroscopic member to the channel wall of the optical channel; and
arranging the extinction member on a side of the hygroscopic member facing the optical channel.
